(19) United States
(12) Patent Application Publication
(10) Pub. No.: US 2008/0026343 A1
(43) Pub. Date: Jan. 31, 2008

(54) Dental apparatus

(76) Inventors: Scott Doenges, West Olive, MI (US); Tom Garrison, Spring Lake, MI (US); Robert Anderson, Coopersville, MI (US)

Correspondence Address: THE WATSON INTELLECTUAL PROPERTY GROUP, PLC, 3133 HIGHLAND DRIVE, SUITE 200, HUDSONVILLE, MI, 49426, US

(21) Appl. No.: 11/880,089

(22) Filed: Jul. 19, 2007

Related U.S. Application Data
(60) Provisional application No. 60/831,791, filed on Jul. 19, 2006.

(51) Int. Cl. A61C 3/06; A61C 17/00

(52) U.S. Cl. 433/125

(57) ABSTRACT

A prophy angle comprising a housing, a paste advancing assembly, and a polishing drive assembly. The paste advancing assembly includes a cavity for retaining a quantity of paste, a piston configured for slidable receipt within the cavity and a nozzle. The polishing drive assembly includes a drive shaft, a drive gear and a cup gear. The drive shaft, the drive gear and the cup gear are each isolated from the cavity of the paste advancing system.

### CROSS REFERENCE TO RELATED APPLICATION

This application claims priority from U.S. Provisional Patent Application Ser. No. 60/831,791 entitled “Dental Apparatus” filed Jul. 19, 2006, the entire specification of which is hereby incorporated by reference in its entirety.

### BACKGROUND OF THE INVENTION

1. Field of the Invention

The invention relates in general to a dental apparatus, and more particularly, to a dental polishing apparatus, i.e., a prophy angle, which is configured to facilitate the dispensing of paste from within the apparatus into a prophy cup upon selective actuation by a user. Advantageously, the drive system is isolated from the paste, thereby facilitating improved operation thereof.

2. Background Art

The use of polishing devices by dental practitioners is well known in the art. Generally, such devices are termed prophy angles, and include a prophy cup which rotates about an axis. The prophy cup includes an inner cavity into which a polishing paste is inserted. Once the polishing paste has been applied to the prophy cup, the prophy cup is rotated and introduced to the teeth of a patient. The rotation of the prophy cup directs the paste along the surface of the teeth, and, by way of abrasion, serves to polish the teeth of the patient.

While the use of prophy angles has been known in the art for several years, there still exist a number of deficiencies associated with such prophy angle use. For example, in certain embodiments, the prophy angle may comprise a reusable device to which separate prophy cups are attached. Once attached, the paste is applied to the prophy cup from a separate, small container. However, use of such reusable devices may introduce health and sanitation risks when transferred from one patient to another, despite the changing of the prophy cup. Therefore, for sanitary purposes, the preferable embodiment of the prophy angle comprises a disposable, single-use device which is utilized for a single patient and is then discarded. However, while the use of disposable devices has been developed, the paste is nevertheless manually applied from a separate container, which may be inconvenient for the dental practitioner.

To remedy this situation, certain new embodiments of prophy angles now incorporate paste dispensing means integrally associated with the prophy angle. While such embodiments exist, certain drawbacks have precluded the widespread acceptance and use of such devices. Among other drawbacks, due to its size, the drive mechanism (gears, shafts, etc.) are typically exposed to paste, such tends to limit the paste that is usable with the device. Additionally, the paste tends to disrupt the normal operation of these drive mechanisms.

As a result, it is an object of the present invention to provide a prophy angle which isolates the drive mechanism from the paste.

It is another object of the invention to provide a prophy angle which has enhanced durability and usability with varying paste compositions.

These and other objects will become apparent in light of the specification and claims appended hereto.

### SUMMARY OF THE INVENTION

The invention is directed to a prophy angle, comprising a housing, a polishing drive assembly and a paste advancing assembly. The housing has a first end and a second end. The housing defines an elongated cavity with an end opening proximate the first end and a side opening proximate the second end.

The polishing drive assembly includes a drive shaft having a first end and a second end. The drive shaft extends through the elongated cavity from the first end to the second end thereof. A drive gear is positioned at the second end of the drive shaft. A cup assembly comprises a cup which has a channel extending therethrough. A portion of the opening defines an operable paste applying region. A cup gear extends about a portion of the outside of the cup. The cup gear is configured to mesh with the drive gear, and to impart rotation of the cup upon rotation of the drive shaft. The axis of rotation of the cup and the axis of rotation of the drive shaft are angled relative to each other.

The paste advancing assembly includes a paste cavity disposed within the elongated cavity. The paste cavity has an introduction end and a dispensing end which is in fluid communication with the operable past applying region. The paste cavity is fluidly isolated from the drive shaft, the drive gear and the cup gear. An assembly for selectively reducing the volume of the paste cavity is provided which directs paste positioned therewith toward and through the dispensing end of the cavity and into the operable paste applying region.

In a preferred embodiment, the cup includes an axis of rotation. The second end of the drive shaft extends beyond the axis of rotation of the cup, and the drive gear is positioned such that the axis of rotation of the cup is between the drive gear and the first end of the drive shaft.

In one such preferred embodiment, the drive gear comprises an inwardly beveled gear.

In another such preferred embodiment, the second end of the housing includes a tab and the second end of the drive shaft includes a notch which interfaces with the tab so as to facilitate the defining of the axis of rotation thereof.

In another such embodiment, the drive shaft includes an axis of rotation which is substantially perpendicular to the axis of rotation of the cup.

In one embodiment, the paste cavity comprises an elongated tubular member having an outer containment wall and an inner containment wall nested therewithin, so as to retain paste therebetween. The drive shaft extends through and within the inner containment wall.

In yet another preferred embodiment, the assembly for selectively reducing volume of the paste cavity comprises a piston and a actuator assembly. The piston is slidably movable within the paste cavity between introduction end of the paste cavity to toward the dispensing end of the paste cavity and sealingly engaging each of the inner and outer containment walls. The actuator assembly is structurally configured to impart selective slidable movement of the piston through the paste cavity.

In one such preferred embodiment, the actuator assembly comprises a ratchet mechanism including a ratchet member coupled to the actuator handle disposed on the outer surface of the housing and a ratchet comprising a plurality of teeth coupled to the piston. Actuation of the actuator handle translates the ratchet member which imparts slidable movement of the ratchet a predetermined distance. The release of the arm facilitates the translation of the ratchet member over at least one tooth of the ratchet.

In one such embodiment, each actuation of the actuator handle reduces the volume of the paste cavity a substantially uniform quantity.

In yet another embodiment, the outer containment wall and inner containment wall define a substantially ring-like cross-sectional configuration. Additionally, the piston has a substantially ring-like cross-sectional configuration.

### BRIEF DESCRIPTION OF THE DRAWINGS

The invention will now be described with reference to the drawings wherein:

FIG. 1 of the drawings comprises a side elevational view of a dental apparatus in accordance with the present invention;

FIG. 2 of the drawings comprises a top plan view of a dental apparatus in accordance with the present invention;

FIG. 3 of the drawings comprises a bottom plan view of a dental apparatus in accordance with the present invention;

FIG. 4 of the drawings comprises a front elevational view of a dental apparatus in accordance with the present invention;

FIG. 5 of the drawings comprises a back elevational view of a dental apparatus in accordance with the present invention;

FIG. 6 of the drawings comprises a cross-sectional view of a dental apparatus in accordance with the present invention taken generally about lines A-A of FIG. 3;

FIG. 7 of the drawings comprises a cross-sectional view of a dental apparatus in accordance with the present invention taken generally about lines B-B of FIG. 1;

FIG. 8 of the drawings comprises a cross-sectional view of a dental apparatus in accordance with the present invention taken generally about lines C-C of FIG. 1;

FIG. 9 of the drawings comprises a cross-sectional view of a dental apparatus in accordance with the present invention taken generally about lines D-D of FIG. 1; and

FIG. 10 of the drawings comprises a cross-sectional view of a dental apparatus in accordance with the present invention taken generally about lines F-F of FIG. 3.

### DETAILED DESCRIPTION OF THE INVENTION

While this invention is capable of embodiment in many different forms, there is shown in the drawings and will be described herein in detail, one specific embodiment with the understanding that the present disclosure is to be considered as an exemplification of the principles of the invention and is not intended to limit the invention to the embodiment illustrated.

It will be understood that like or analogous elements and/or components, referred to herein, are identified throughout the drawings by like reference characters. In addition, it will be understood that the drawings are merely representations, and some of the components may have been distorted from actual scale for purposes of pictorial clarity.

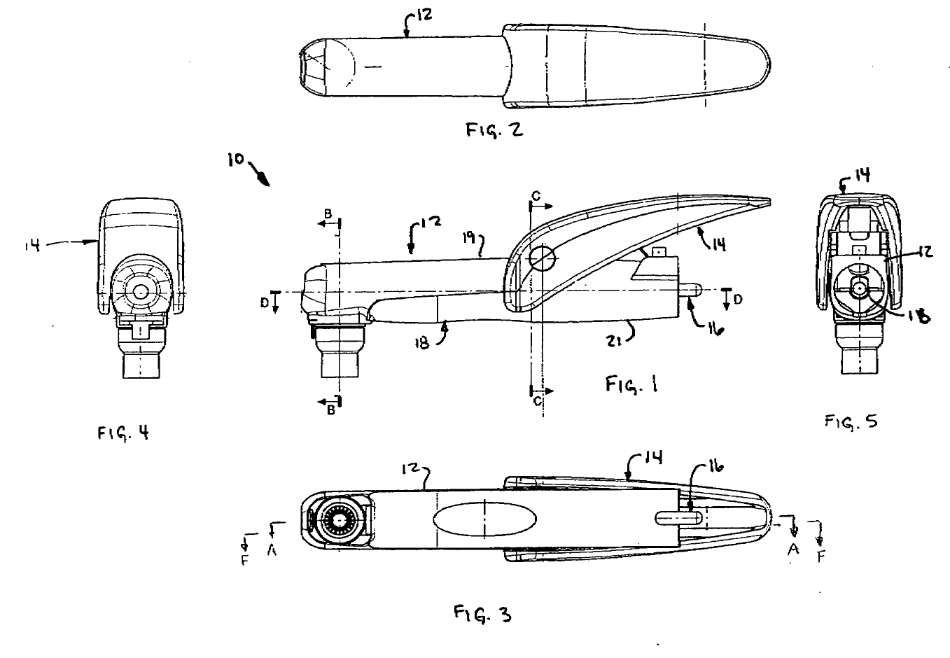

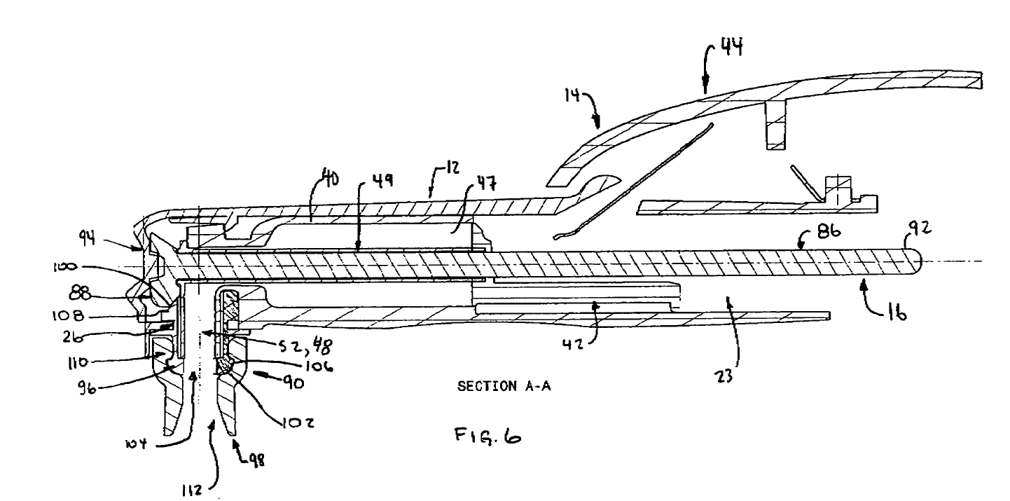

Dental apparatus 10 (commonly referred to as a prophy angle) is shown in FIG. 1 as comprising housing 12, paste advancing assembly 14, and polishing drive assembly 16. As shown in FIG. 9, prophy angle 10 is designed for use with low speed dental hand piece 400 commonly found in a dental office. Generally, such prophy angles are formed entirely from plastic and/or rubber materials, which render the apparatus disposable. Of course, it is likewise contemplated that the device may be reusable.

Referring again to FIG. 1, housing 12 includes elongated body 18 which is formed from two case halves 19 and 21. With reference to FIG. 9, body 18 extends from a first end 20 to a second end 22 and defines cavity 23. Tool receiving opening 24 is positioned at first end 20 and provides ingress into cavity 23. As is shown in FIG. 7, drive assembly opening 26 is positioned at second end 22. The drive assembly opening is substantially angled relative to the tool receiving opening. In the present embodiment the two openings are substantially perpendicular. In other embodiments, they may be oblique to each other at an angle which is other than perpendicular.

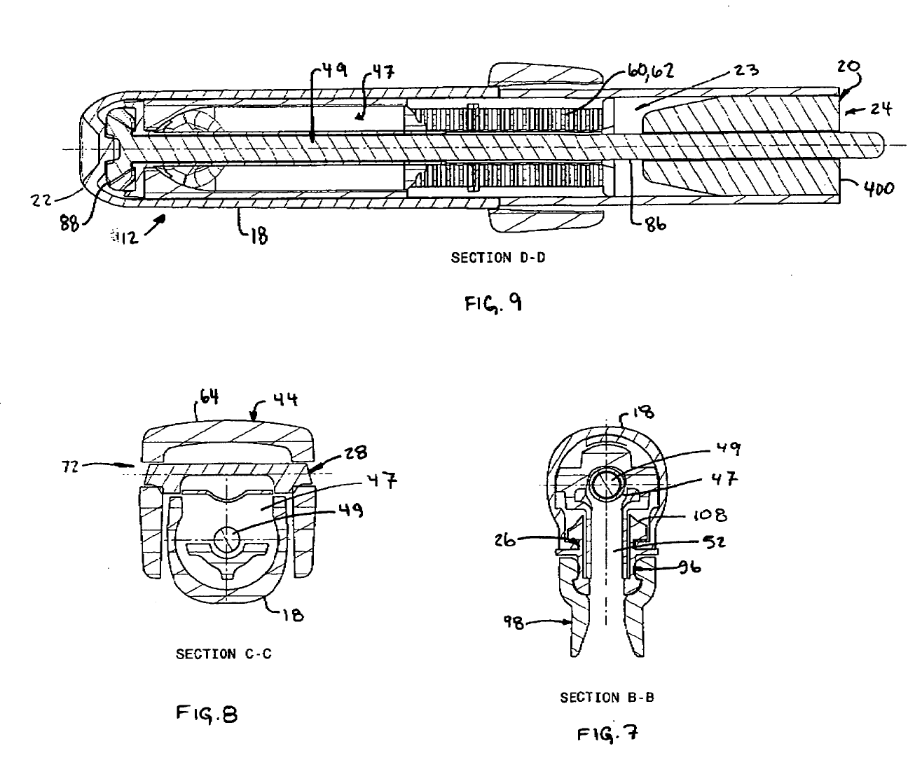

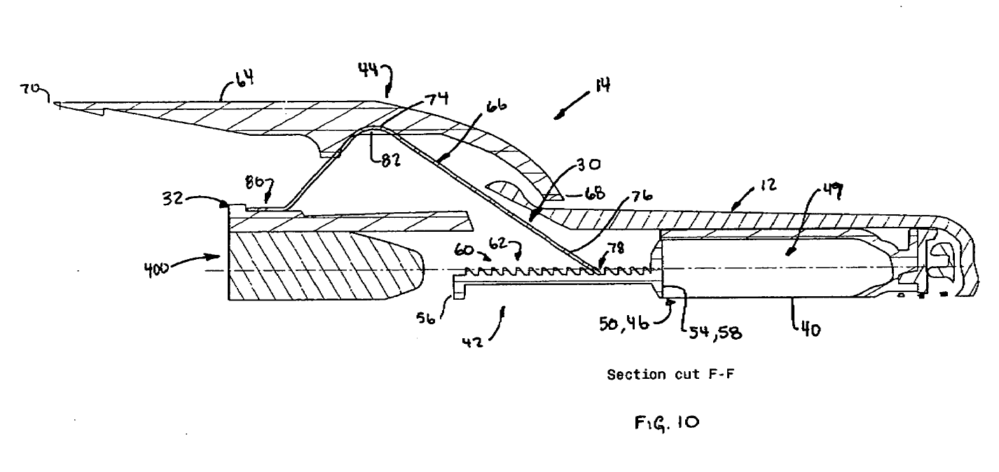

With reference to FIGS. 8 and/or 10, the elongated body further includes handle anchor assembly 28 (FIG. 8), top slot opening 30 (FIG. 10) and ridge 32 (FIG. 10). The handle anchor assembly 28 is positioned between the first and second ends. The top slot opening provides an ingress into cavity 23. As will be explained the ridge 32 coordinates with the ratchet member 66 of the handle assembly 44.

Preferably, housing 12 I formed from two halves which are both molded polymer members. It is contemplated that other materials may be utilized in place of the molded polymer members.

Paste advancing assembly 14 is shown partially in each of FIGS. 6 and 10 as comprising paste containment housing 40, piston 42 and handle assembly 44. Paste containment housing 40 includes first or introduction end 46, second or dispensing end 48, opening 50 and nozzle 52. Opening 50 is positioned at first end 46 and nozzle 52 is positioned at second end 48. The housing 40 essentially defines paste holding cavity 47 between an outer containment wall and an inner containment wall 49. Typically the paste holding cavity 47 is configured to retain a predetermined amount of paste, such as a quantity of paste that would be utilized by a dental practitioner on a single patient, or for a single row of teeth. As is shown in FIGS. 6 and 9, inner containment wall 49 extends longitudinally through the paste holding cavity 47. The inner containment wall is configured to receive drive shaft 86 and to isolate the drive shaft assembly from the paste contained within the cavity.

Piston 42, which forms an assembly for selectively reducing the volume of the paste cavity, is shown in FIG. 10 as including first end 54, second end 56 paste engaging surface 58 and handle engaging surface 60. The piston is configured to slide within paste holding cavity 47, as such, the cross-sectional configurations substantially match. In the embodiment shown, the cross-section comprises a substantially ring-like cross-sectional configuration to match the paste cavity. As such, the piston sealingly engages the walls of the paste cavity. Handle engaging surface 60 extends from first end 54 to second end 56 and includes ratchet surface 62. It will be understood that an opening is present in the piston which corresponds to the channel 49 in the paste containment housing for permitting the passage of the drive shaft therethrough.

With reference to FIG. 10, handle assembly 44, which forms the actuator assembly, includes handle member 64 and ratchet member 66. The handle member 64 includes first end 68, second end 70, anchors, such as anchor 72 (FIG. 8) and ratchet engaging region 74. The second end 70 of handle member 64 is configured for receipt of a finger of a practitioner and rotation thereof about the anchors 72.

Ratchet member 66 includes body 76, first end 78, second end 80 and engaging region 82. Typically, the ratchet member 66 is formed from a spring steel material, or a similar material. The ratchet member is typically bent about the engaging region 82 which interfaces with ratchet engaging region 74. The first end 78 interfaces with ratchet 62 and the second end 80 interfaces with ridge 32. It will be understood that as the second end of the handle assembly is rotated, the second end of the ratchet member advances the piston 42. When released, the second end of the ratchet member skips over a tooth of ratchet 62 thus, leaving the piston in the advanced position, and returning to a position wherein the next rotation of the handle will again advance the piston.

Polishing drive assembly 16 is shown in FIG. 6 as including drive shaft 86, drive gear 88 and cup assembly 90. The drive shaft includes first end 92 and second end 94. The drive shaft extends from first end 20 to second end 22 of the elongated body of the housing, and, through the channel 49 of the paste containment housing 40. Thus, the spinning drive shaft is fully isolated from the paste. Drive gear 88 is positioned at the second end 94 of the drive shaft. Again, the drive gear is positioned such that it does not co-act with the paste. In the embodiment shown, the drive gear comprises a inwardly directed beveled gear.

Cup assembly 90 includes cup shaft 96 and cup member 98. The cup shaft has a first end 100, a second end 102, channel 104, cup engagement member 106 and cup gear 108. The nozzle 52 extends through channel 104. Cup gear 108 extends about the outside of the cup shaft and interfaces with the drive gear 88. In another embodiment, a single shaft which is flexible may be incorporated. Such a flexible shaft has the ability to alter the axis of rotation along the length thereof, to, in turn, impart rotation of the cup with a single drive shaft.

Cup member 98 includes shaft engagement region 110 and paste receiving channel 112, which comprises an operable paste applying region (from where past is applied to the tooth). The shat engagement region 110 interfaces with the cup engagement member 106 of the cup shaft. Typically, the cup member is formed from a soft polymer, such as a rubber member, whereas the cup shaft is formed from a more durable (harder) polymer member. In certain embodiments, these two may be separate members which are mechanically connected. In other embodiments, they may be co-molded members.

Paste receiving channel 112 is substantially collinear with the nozzle 52 and the channel 104 of the cup shaft such that when the piston is advanced by the handle member, and the paste is driven out of the nozzle of the paste containment housing, the paste is directed into the paste receiving channel such that it is ready for use.

Advantageously, the polish drive assembly including the gears and the drive shaft are isolated from the paste. As a result, the device can expunge paste for use in the polishing procedure, but the paste will not interfere with or otherwise hamper the operation of the drive shaft or the gears. In turn, the advancing paste and the drive shaft can operate free from engagement with each other. Moreover, due to the separation of the paste, a number of different paste compositions may be contemplated without substantial regard for contamination with the drive shaft and the drive gears.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A prophy angle, comprising:
a housing having a first end and a second end, the housing defining an elongated cavity with an end opening proximate the first end and a side opening proximate the second end;
a polishing drive assembly including a drive shaft having a first end and a second end, the drive shaft extending through the elongated cavity from the first end to the second end thereof, having a drive gear positioned at the second end of the drive shaft and a cup assembly comprising a cup having a channel extending therethrough, a portion of the opening defining a operable paste applying region, and a cup gear extending about a portion of the outside of the cup, the cup gear configured to mesh with the drive gear so as to impart rotation of the cup upon rotation of the drive shaft, wherein the axis of rotation of the cup and the drive shaft are angled relative to each other,
a paste advancing assembly including a paste cavity disposed within the elongated cavity, the paste cavity having a introduction end and a dispensing end which is in fluid communication with the operable paste applying region, the paste cavity fluidly isolated from the drive shaft, drive gear and cup gear, and an assembly for selectively reducing the volume of the paste cavity so as to direct paste positioned therewith toward and through the dispensing end of the cavity and into the operable paste applying region.

2. The prophy angle of claim 1 wherein the cup includes an axis of rotation, the second end of the drive shaft extends beyond the axis of rotation of the cup, and the drive gear is positioned such that the axis of rotation of the cup is between the drive gear and the first end of the drive shaft.

3. The prophy angle of claim 2 wherein the drive gear comprises an inwardly beveled gear.

4. The prophy angle of claim 3 wherein the second end of the housing includes a tab and the second end of the drive shaft includes a notch which interfaces with the tab so as to facilitate the defining of the axis of rotation thereof.

5. The prophy angle of claim 2 wherein the drive shaft includes an axis of rotation which is substantially perpendicular to the axis of rotation of the cup.

6. The prophy angle of 1 wherein the paste cavity comprises an elongated tubular member having an outer containment wall and an inner containment wall nested therewithin, so as to retain paste therebetween, the drive shaft extending through and within the inner containment wall.

7. The prophy angle of claim 6 wherein the assembly for selectively reducing volume of the paste cavity comprises a piston slidably movable within the paste cavity between introduction end of the paste cavity to toward the dispensing end of the paste cavity and sealingly engaging each of the inner and outer containment walls, and an actuator assembly structurally configured to impart selective slidable movement of the piston through the paste cavity.

8. The prophy angle of claim 7 wherein the actuator assembly comprises a ratchet mechanism including a ratchet member coupled to the actuator handle disposed on the outer surface of the housing and a ratchet comprising a plurality of teeth coupled to the piston, wherein actuation of the actuator handle translates the ratchet member which imparts slidable movement of the ratchet a predetermined distance, and the release thereof facilitates the translation of the ratchet member over at least one tooth of the ratchet.

9. The prophy angle of claim 8 wherein each actuation of the actuator handle reduces the volume of the paste cavity a substantially uniform quantity.

10. The prophy angle of claim 7 wherein the outer containment wall and inner containment wall define a substantially ring-like cross-sectional configuration, and wherein the piston has a substantially ring-like cross-sectional configuration.

11. A prophy angle, comprising:
a housing having a first end and a second end, the housing defining an elongated cavity with an end opening proximate the first end and a side opening proximate the second end;
a polishing drive assembly including a drive shaft and a cup assembly comprising a cup having a channel extending therethrough, a portion of the opening defining a operable paste applying region, the drive shaft is coupled to the cup and structurally configured to impart rotation upon the cup,
a paste advancing assembly including a paste cavity disposed within the elongated cavity, the paste cavity having a introduction end and a dispensing end which is in fluid communication with the operable paste applying region, the paste cavity fluidly isolated from the drive shaft, and an assembly for selectively reducing the volume of the paste cavity so as to direct paste positioned therewith toward and through the dispensing end of the cavity and into the operable paste applying region.
